(19) United States
(12) Patent Application Publication
(10) Pub. No.: US 2019/0130411 A1
(43) Pub. Date: May 2, 2019

(54) METHOD AND SYSTEM FOR DATA PROCESSING

(71) Applicant: Alibaba Group Holding Limited, George Town, KY (US)

(72) Inventors: Haidong Li, Hangzhou (CN); Linjian Fang, Hangzhou (CN); Jun Zuo, Hangzhou (CN)

(21) Appl. No.: 16/144,797

(22) Filed: Sep. 27, 2018

Related U.S. Application Data
(63) Continuation-in-part of application No. PCT/CN2017/077690, filed on Mar. 22, 2017.

(30) Foreign Application Priority Data
Mar. 30, 2016 (CN) 201610195484.9

(51) Int. Cl. G06Q 20/40; G06Q 20/08; G06F 9/4401

(52) U.S. Cl. CPC G06Q 20/40145; G06F 9/4418; G06Q 20/085

(57) ABSTRACT

Data processing is disclosed including receiving payment wake-up data, the payment wake-up data comprising biometric data, executing verification based on the payment wake-up data, and in response to a successful verification based on the payment wake-up data, displaying a payment page to execute payment.

### CROSS REFERENCE TO OTHER APPLICATIONS

This application is a continuation-in-part of and claims priority to International (PCT) Application No. PCT/CN2017/77690 entitled DATA PROCESSING METHOD, DEVICE AND SMART TERMINAL filed Mar. 22, 2017 which is incorporated herein by reference in its entirety for all purposes, which claims priority to China Patent Application No. 201610195484.9 entitled A DATA PROCESSING METHOD, DEVICE, AND SMART TERMINAL filed on Mar. 30, 2016 which is incorporated by reference in its entirety for all purposes.

### FIELD OF THE INVENTION

The present application relates to a method and a system for data processing.

### BACKGROUND OF THE INVENTION

With the development of internet finance and Online to Offline (O2O), the number of application scenarios for offline payment has been increasing. In other words, in such scenarios as offline shopping and dining, users do not need to use cash but can instead pay directly using a smart terminal such as a mobile telephone.

Typically, users can use payment applications (apps) equipped with offline payment functionality. To use such a payment application, the user is to open the payment application on the smart terminal, then click and launch a payment page to show a dynamic payment code. Subsequently, the merchant completes authorization of the payment by scanning the dynamic payment code using a handheld scanner.

As an aspect, in the event that a user uses a payment application to perform offline payment, and in the event that the smart terminal is in the locked state, the smart terminal is to be unlocked and the payment application is to be found and launched; in the event that the user is using the smart terminal to execute other operations, the user is to exit the current application and then launch the payment application, making the payment operation relatively cumbersome.

### SUMMARY OF THE INVENTION

The technical problem that the present application addresses involves a process for data processing to resolve cumbersome offline payment operations using smart terminals.

Correspondingly, the present application further discloses a device for data processing to implement the above process.

The present application discloses a process for data processing, comprising: receiving payment wake-up data, wherein the payment wake-up data comprises biometric data; executing verification based on the payment wake-up data; and after the verification has been successfully made, displaying a payment page to execute payment.

In some embodiments, the executing of the verification based on the payment wake-up data comprises: performing, based on identity verification information of a user using a smart terminal, an identity check with respect to the payment wake-up data; in response to a determination that the identity check has been successful, determining whether the payment wake-up data has a wake-up tag; and in response to a determination that the payment wake-up data has a wake-up tag, confirming that the user has passed verification.

In some embodiments, the determining of whether the payment wake-up data has a wake-up tag comprises: retrieving identifier information corresponding to the payment wake-up data; and checking, based on the identifier information, whether the payment wake-up data has a wake-up tag.

In some embodiments, in the event that the payment wake-up data corresponds to fingerprint data, the execution of the verification based on the payment wake-up data comprises: comparing the fingerprint data against a user's fingerprint information stored in a system; in response to a determination that the fingerprint data matches the user's fingerprint information stored in the system, retrieving a fingerprint identifier of an identical user's fingerprint information; checking whether the fingerprint data has a wake-up tag based on the fingerprint identifier; and in response to a determination that that fingerprint data has the wake-up tag, confirming that the user has passed verification.

In some embodiments, the process further comprises: collecting fingerprint information of at least one user in advance, and configuring a fingerprint identifier for fingerprint information of each user; selecting fingerprint information of a target user; and configuring a wake-up tag for the fingerprint information of the target user.

In some embodiments, the receiving of the payment wake-up data comprises: receiving the payment wake-up data in the event that a screen is in the locked state.

In some embodiments, the displaying of the payment page comprises: after the verification has been successfully made, unlocking the screen, retrieving a payment page of a target application, and displaying the payment page.

In some embodiments, the receiving of the payment wake-up data comprises: receiving the payment wake-up data in the event that a screen is in the unlocked state.

In some embodiments, the displaying of the payment page comprises: after the verification has been successfully made, retrieving the payment page of a target application; and jumping to display the payment page.

In some embodiments, the biometric data comprises at least one of the following: fingerprint data, voiceprint data, iris data, and facial feature data.

In some embodiments, the identity verification information comprises unlocking information.

The present application further discloses a device for data processing, comprising: a receiving module configured to receive payment wake-up data, wherein the payment wake-up data comprises biometric data; a verification module configured to execute verification based on the payment wake-up data; a wake-up and display module configured to after the verification has been successfully made, display the payment page to execute payment.

In some embodiments, the verification module comprises: an identity verification module configured to perform an identity check with respect to the payment wake-up data using identity verification information of a system; a tag judging module configured to in the event that the identity check has been successful, determine whether the wake-up data has a wake-up tag; and in response to a determination that the wake-up data has the wake-up tag, confirm that a user has passed verification.

In some embodiments, the tag judging module is further configured to retrieve identifier information corresponding to the payment wake-up data; and check whether the payment wake-up data has a wake-up tag based on the identifier information.

In some embodiments, the verification module comprises: an identity verification module configured to in the event that the wake-up data is fingerprint data, compare the fingerprint data against fingerprint information of the user stored in the system; a tag judging module configured to in the event that the fingerprint data is identical to the stored fingerprint information of the user, retrieve a fingerprint identifier of the fingerprint information of the user; check whether fingerprint data has a wake-up tag based on the fingerprint identifier; and in response to a determination that the fingerprint data has the wake-up tag, confirm that the user has passed verification.

In some embodiments, the device further comprises: a collecting module configured to collect fingerprint information of at least one user in advance, and configure a fingerprint identifier for fingerprint information of each user; and a tag configuring module configured to select fingerprint information of a target user, and configure a wake-up tag for the fingerprint information of the target user.

In some embodiments, the receiving module is configured to receive the payment wake-up data in the event that the screen is in a locked state.

In some embodiments, the wake-up and display module comprises: an unlocking module configured to after the verification has been successfully made, unlock the screen; and a display module configured to retrieve a payment page of the target application, and display the payment page.

In some embodiments, the receiving module is further configured to receive the payment wake-up data in the unlocked state.

In some embodiments, the wake-up and display module is configured to after the verification has been successfully made, retrieve the payment page of the target application, and jump to display the payment page.

In some embodiments, the biometric data comprises at least one of the following: fingerprint data, voiceprint data, iris data, and facial feature data.

In some embodiments, the identity verification information comprises unlocking information.

The present application further discloses a smart terminal, the smart terminal comprising: memory, a display device, a processor, and an input unit, wherein the input unit comprises: a touchscreen; and the processor is used to execute the above process for data processing.

Compared to conventional technique, the present application includes at least the following benefits:

In the present application, payment wake-up data is received, wherein the payment wake-up data comprises biometric data; verification is executed based on the payment wake-up data, and after the verification has been successfully made, a payment page is displayed to execute payment; the accuracy of verification is increased using biometric data, and the user is able to wake up the payment page to execute payment in the event that the user enters the payment wake-up data, simplifying the operations of payment to be simple and efficient, thus saving time.

### BRIEF DESCRIPTION OF THE DRAWINGS

Various embodiments of the invention are disclosed in the following detailed description and the accompanying drawings.

FIG. 1 is a flowchart of an embodiment of a process for data processing.

FIG. 2 is a flowchart of another embodiment of a process for data processing.

FIG. 3 is a flowchart of an embodiment of a process for processing a fingerprint wake-up offline payment.

FIG. 4 is a structural block diagram of an embodiment of an embodiment of a device for data processing.

FIG. 5 is a structural block diagram of another embodiment of a device for data processing.

FIG. 6A is a structural block diagram of an embodiment of a device for processing a fingerprint wake-up offline payment.

FIG. 6B is a structural block diagram of an embodiment of a verification module.

FIG. 6C is a structural block diagram of an embodiment of a wake-up and display module.

FIG. 7 is a functional diagram illustrating a programmed computer system for data processing in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The process and the device for data processing address the problem of cumbersome offline payment operations using smart terminals. In some embodiments, payment wake-up data is received, wherein the payment wake-up data comprises biometric data. Verification is executed based on the payment wake-up data, and after the verification has been successfully made, the payment page is displayed to execute payment; and the accuracy of verification is increased using the biometric data, simplifying and making more efficient the operations, thus saving time.

In some embodiments, the smart terminals refer to terminal devices that have multimedia functionality, the terminal devices support functions such as audio, video, and data. In some embodiments, the smart terminals have touchscreens, and include smart mobile terminals such as smartphones, tablet computers, smart wearable devices, and also include devices such as smart televisions and personal computers with touchscreens.

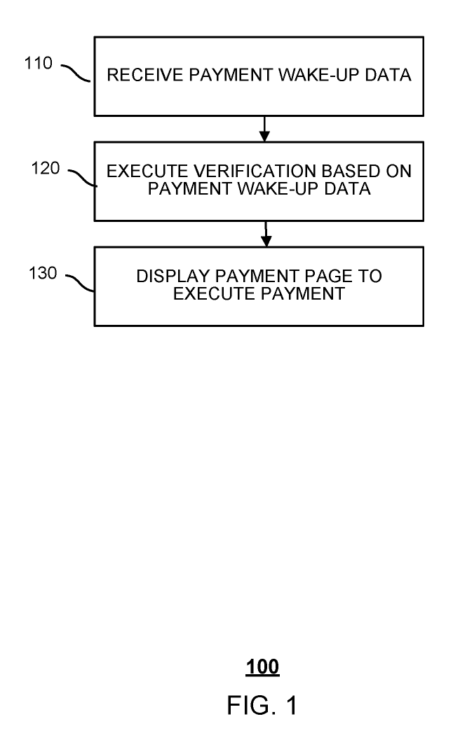

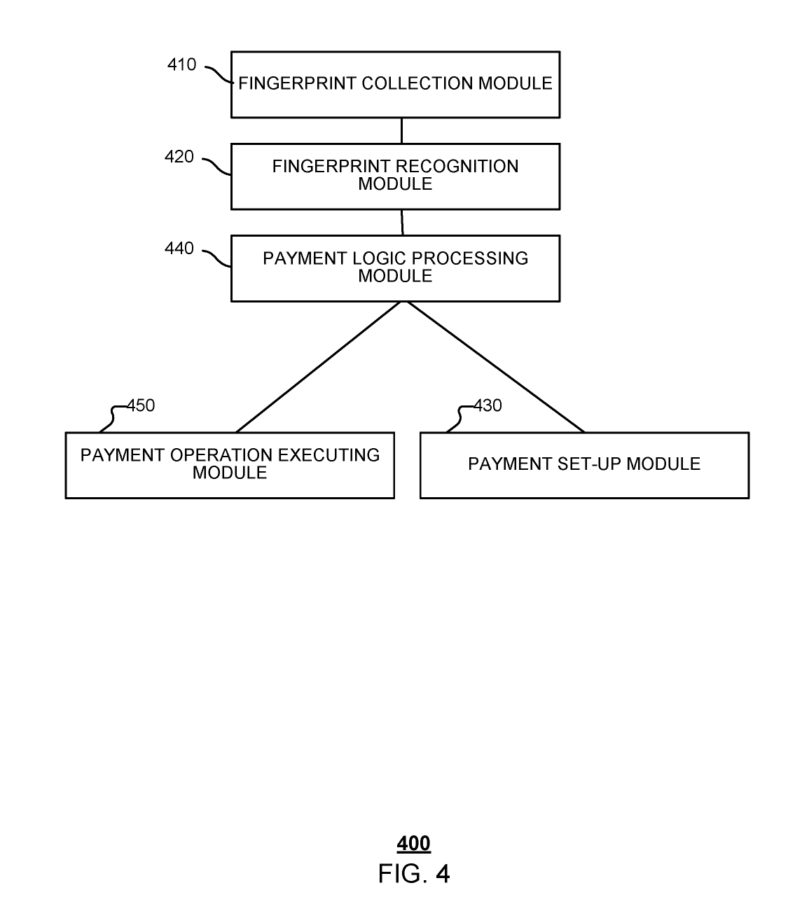

FIG. 1 is a flowchart of an embodiment of a process for data processing. In some embodiments, the process 100 is implemented by a device or smart terminal 400 of FIG. 4 and comprises:

In 110, the device receives payment wake-up data. In some embodiments, the payment wake-up data includes biometric data.

In 120, the device executes verification based on the payment wake-up data.

In 130, after the verification has been successfully made, the device displays a payment page to execute payment.

With the development of internet finance and O2O technology, an increasing number of users use payment applications on smart terminals to perform offline payment. In some embodiments, by entering the payment wake-up data, a payment page can be woken up once to perform the payment is displayed to execute payment, and the operations are simplified. The payment includes offline payment. In some embodiments, payments targeting transactions that are not conducted online can be referred to as offline payments. For example, payments made when a user shops in a physical store, dines in a restaurant, checks into a hotel, etc. are all referred to as offline payments.

The user can enter payment wake-up data on a smart terminal at any time. For example, the payment wake-up data is entered in the event that the screen is in a locked state, or in the event that other applications are being used. In some embodiments, the payment wake-up data comprises biometric data, thereby enabling identification of the user based on the biometric data to accurately determine the user and display an offline payment page. As a result, accuracy and security are increased. In some embodiments, each individual has unique physiological features or behaviors that are measurable or are automatically recognized and verified, i.e., biometrics, and the biometrics can be divided into physiological features (such as fingerprints, face images, irises, palm prints, etc.) and behavioral features (such as gait, voice, handwriting, etc.). Biometric recognition is the recognition and authentication of the identity of individuals based on the individuals' unique biological features.

Therefore, verification can be executed based on the payment wake-up data. In some embodiments, the verification is performed to verify the authority to wake up and display the payment page, and the verification is used to verify the payment wake-up data, so that, after verification has been successfully made, the payment page can be displayed to execute payment.

The smart terminal correspondingly receives the payment wake-up data, whereupon the smart terminal can perform verification based on the payment wake-up data by waking up and retrieving a payment page, and display the payment page to enable the user to show the payment page to the merchant, so that the merchant can perform payment operations such as scan-to-pay.

In other words, payment wake-up data can be received. In some embodiments, the payment wake-up data includes biometric data, and verification is executed based on the payment wake-up data; and after the verification has been successfully made, the payment page is displayed to execute payment. The accuracy of verification is increased through the use of biometric data, and by entering the payment wake-up data, the user is able to wake up and display the payment page to execute payment, simplifying the operations of payment, so that operations are simple and efficient, thus saving computing resources and time.

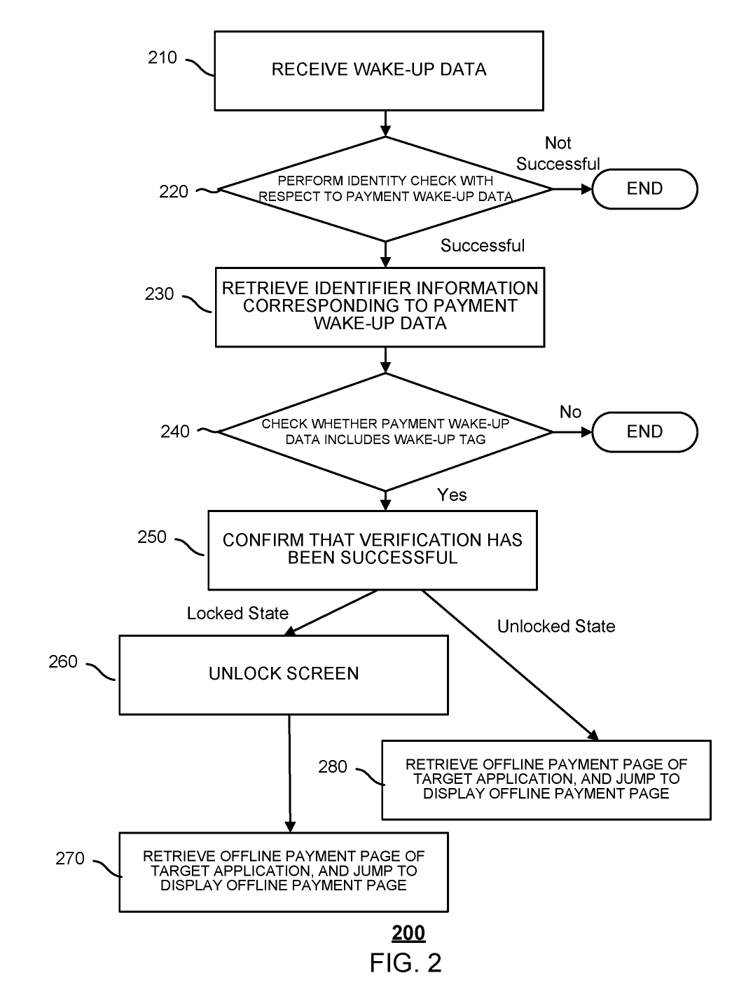

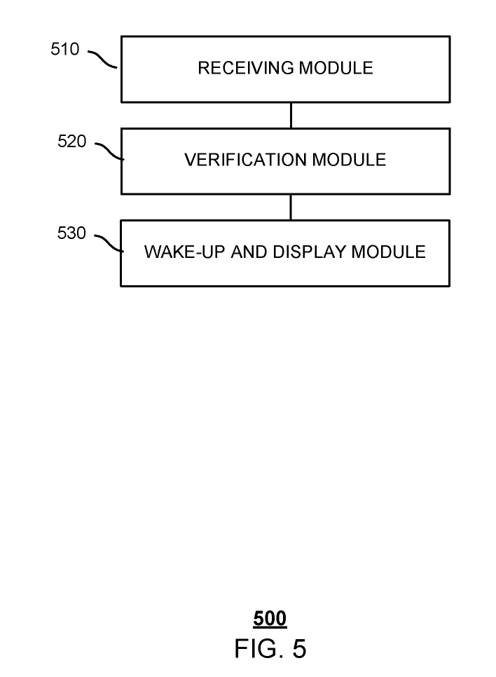

FIG. 2 is a flowchart of another embodiment of a process for data processing. In some embodiments, the process 200 is implemented by the device or smart terminal 500 of FIG. 5 and comprises:

In some embodiments, the smart terminal 500 uses payment wake-up data to directly wake up and displays the payment page, and thereby executes payment to increase convenience of use to users.

In some embodiments, the payment wake-up data comprises biometric data, and the biometric data comprises at least one of the following: fingerprint data, voiceprint data, iris data, facial feature data, etc. In some embodiments, the payment wake-up data further comprise other biometric data, such as palm prints. In addition, the payment wake-up data can include password combinations that include characters such as numbers or symbols.

In some embodiments, fingerprints include lines formed by concave and convex skin in the pulp of the finger on human fingertips. The fingerprints can be unique, hereditary, and immutable, and have sufficient characteristics for differentiation. The fingerprint data can be generated by collecting the fingerprints.

In some embodiments, a voiceprint is an acoustic spectrum carrying speech information, displayed by an electroacoustic instrument. Voiceprints are specific and relatively stable, and can be used for user-to-user recognition. The voiceprint data can be generated by collecting audio clips of users speaking.

The iris makes up the middle of the eyeball and is located in the forward-most portion of the tunica vasculosa lentis. The iris is unique and immutable, and can serve as a feature for recognition of user identity. The iris data can be extracted by photographing the user's eye.

Other biometric features of the face and body (fingerprints and irises) are all congenital, and the positive characteristics of uniqueness and difficulty of replication provide the prerequisites for identity verification. The facial feature data can be extracted by capturing images of users' faces.

Therefore, the biometric data can be used as the payment wake-up data to perform recognition, upon receiving the payment wake-up data, the payment page is displayed, facilitating the user's ability to retrieve the payment page and execute payment with one-time input. The example of offline payment is used.

In 210, the smart terminal receives wake-up data, the smart terminal being in a locked state or an unlocked state.

When using the smart terminal, the user can enter the payment wake-up data at any time, and the payment wake-up data is used to wake up the offline payment page. The biometric data input can be triggered by a process of the operating system, and the offline payment page can also be triggered by the operating system. The payment wake-up data can include biometric data, such as fingerprints. In some embodiments, the smart terminal receives the payment wake-up data in the locked state, in which case, the smart terminal is unlocked and the wake-up of the offline payment can be performed using the payment wake-up data. The smart terminal can also receive the payment wake-up data in the unlocked state. For example, the smart terminal receives the payment wake-up data in the event that the smart terminal is displaying the system interface or an application is running, in which case the current page (e.g., the system interface or the current application) can be exited and the wake-up of the offline payment can be executed using the payment wake-up data.

After the smart terminal receives the payment wake-up data, the smart terminal can execute verification based on the payment wake-up data. In some embodiments, the verification is used to verify the authority to wake up and display the offline payment page; and after verification has been successfully made, the offline payment page can be displayed to execute offline payment.

As an example, the following operations can be performed for verification:

In 220, the smart terminal performs, based on identity verification information of a user, an identity check with respect to the payment wake-up data.

In some embodiments, to protect the system security of the smart terminal, typically, identity verification information is configured for the smart terminal, such as locking and unlocking information, identity authentication data, etc., thus enabling unlocking based on the unlocking information in the event that the smart terminal screen is locked, and the user's identity is checked is the event that an application with higher security requirements is being used, or the user's identity is verified during system upgrades, software downloads, power up or shut-down. Biometric data can be used for the identity verification information of the smart terminal, and password data can also be used, for example, unlocking via password and fingerprint.

Therefore, the payment wake-up data can be configured as one piece (among one or more pieces) of the system's identity verification information, thus enabling verification of the user's identity before the wake-up of the payment application, and enabling direct verification using the unlocking information included in the identity verification information in the locked state, for one-step payment wake-up, which both increases the security of offline payment, and increases the efficiency of payment page wake-up. Correspondingly, in the event that verification is being performed, the system's identity verification information can be used to perform an identity check with respect to the payment wake-up data. For example, by comparing the payment wake-up data against the identity verification information, the smart terminal determined whether the payment wake-up data matches the identity verification information. In some embodiments, in the event that the smart terminal is able to collect biometric data such as fingerprints, although the user has entered biometric data to facilitate verification of identity when necessary, a password is still required to unlock the device. Therefore, the biometric data of this smart terminal is able to verify identity but is not used for unlocking the smart terminal. In some embodiments, in the event that the user uses the smart terminal, the biometric data can be used to perform an identity check, and thereby wake up the payment page.

In the event that verification has been successfully made, for example, a determination is made that the payment wake-up data matches the identity verification information, then control passes to operation 230; otherwise, in the event that verification has not been successfully made, for example, a determination is made that the payment wake-up data does not match the identity verification information, then this process terminates. In some embodiments, a prompt message can be returned to the user to inform the user that verification has failed, and the user can re-enter the data.

In 230, the smart terminal retrieves identifier information corresponding to the payment wake-up data.

In 240, the smart terminal checks whether the payment wake-up data includes a wake-up tag based on the identifier information. The wake-up tag can be in any form.

In some embodiments, in the event that the user enters data, the entering of the data is only used to verify identity and unlock the device, and the user need not perform offline payment. For example, only unlocking a smart terminal is performed in the locked state, or only the identity check is performed in the event that the smart terminal is rebooted. At such times, in the event that a successful comparison serves as the criterion for passing verification, the offline payment page, which is not needed by the user, can be displayed. Therefore, to prevent operation errors, in some embodiments, wake-up tags are configured in the unlocking information to prevent operation errors. In some embodiments, the wake-up tag is a special identifier that the user of the smart terminal puts in the system settings for a biometric template that has been entered (i.e., the payment wake-up data). The biometric template with the wake-up tag can invoke a payment page when activated during feature recognition. By using the comparison as the criterion for determining that the identity check has been successful, a further determination can be performed as to whether the payment wake-up data has a wake-up tag, i.e., determining whether the unlocking information that matches the payment wake-up data has a wake-up tag. The identifier information corresponding to the payment wake-up data can be retrieved, i.e., retrieving the identifier information corresponding to the data included in the unlocking information that matches the payment wake-up data, to determine whether the data corresponding to this identifier information has a wake-up tag.

In the event that the data corresponding to this identifier information has a wake-up tag, i.e., in the event that the payment wake-up data has a wake-up tag, then operation 250 is performed. In the event that the data corresponding to this identifier information does not have a wake-up tag, i.e., in the event that the payment wake-up data does not have a wake-up tag, then this process terminates. Of course, a prompt message can be returned to the user to inform the user that verification has failed, and the user can re-enter the data.

In 250, the smart terminal confirms that verification has been successful.

In response to a determination that the identity check has been successful and the payment wake-up data has a wake-up tag, then the verification that has been passed can be confirmed. In response to a determination that the verification has been successfully made, the wake-up of offline payment can be performed. In some embodiments, smart terminals in different states are to respond by executing different operations.

In the event that the smart terminal was previously in a locked state, then control is passed to operation 260. In the event that the smart terminal was previously in the unlocked state, then then control is passed to 280.

In 260, the smart terminal unlocks the screen.

In 270, the smart terminal retrieves an offline payment page of the target application, and displays the offline payment page. For example, the operating system of the smart terminal retrieves the offline payment page from the target application.

In the event that the wake-up data is received when the screen is in the locked state, then during the process of executing verification, by comparing the payment wake-up data with the unlocking information, the unlocking check has essentially been executed. Therefore, the verification is treated as a confirmation that the comparison matches indicates that the unlocking check was successful, thus after verification has been successfully made, the screen can first be unlocked, and then the offline payment page of the target application can be retrieved and the offline payment page can be displayed.

In 280, the smart terminal retrieves an offline payment page of the target application, and jumps to display the offline payment page.

In the event that the payment wake-up data is received in the unlocked state, after verification has been successfully made, the offline payment page of the target application can be retrieved, and then the terminal can jump from the current interface to display the offline payment page. For example, the jump to the payment page is based on an identifier of the payment page, and the identifier corresponds to a Uniform Resource Locator (URL). For example, in the event that the initial display is the operating system interface, then after verification has been successfully made, the target application can be launched and the offline payment page can be displayed. In another example, in the event that the initial display is the page of an application, then, after verification has been successfully made, the running of the application can be terminated, and the terminal can jump to launch the target application and display the offline payment page. In yet another example, in the event that the current display is a page of the target application, then the terminal can directly jump to the offline payment page of the target application.

In some embodiments, using an example of offline payment, the user has stored multiple payment applications with offline payment functionality on the smart terminal. In this case, the target application for wake-up can be determined based on payment wake-up data entered. For example, a default startup target application can be configured, or in another example, different target applications can be configured based on identifier information corresponding to the payment wake-up data. In the event that an offline payment page is retrieved, the target application is determined based on the identifier information corresponding to the payment wake-up data before the offline payment page of the target application is retrieved. In some embodiments, payment applications that have offline payment functionality provide an interface for the payment applications' offline payment pages, so that after verification has been passed, the offline payment page can be invoked and displayed using the interface.

The offline payment wake-up steps will be discussed using the example of fingerprints as the biometric data.

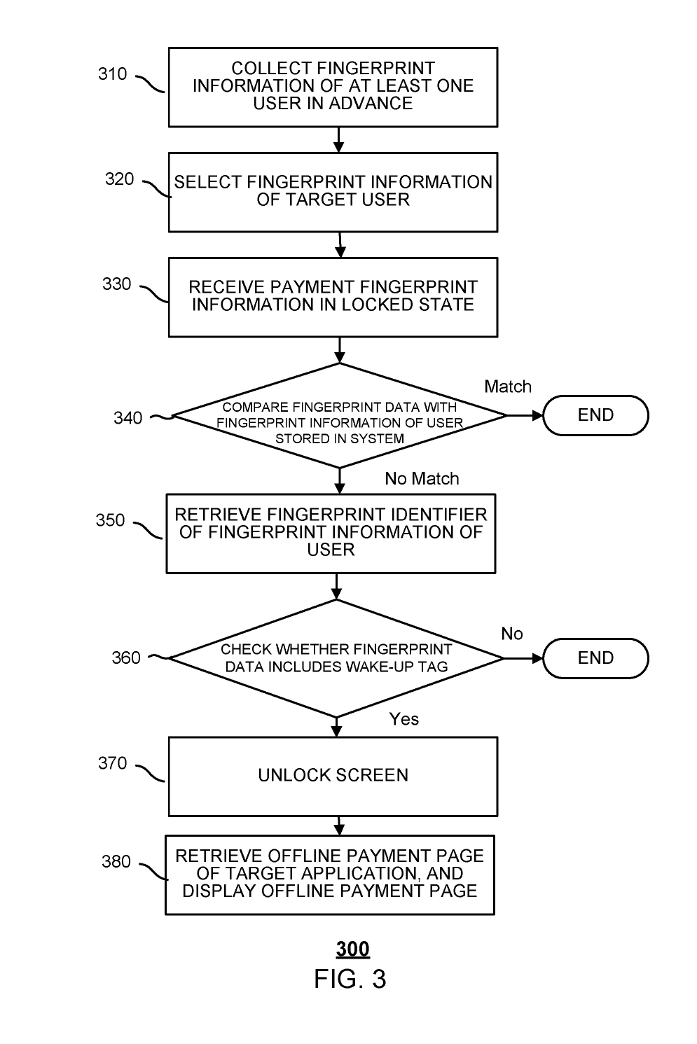

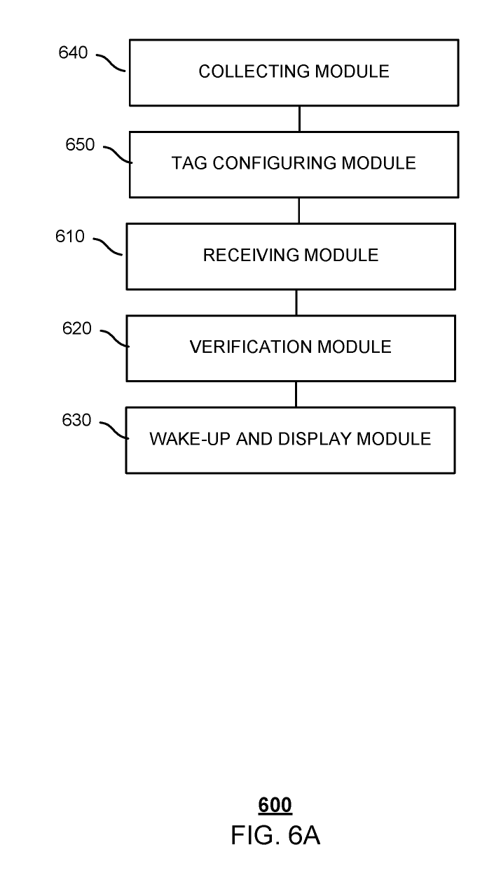

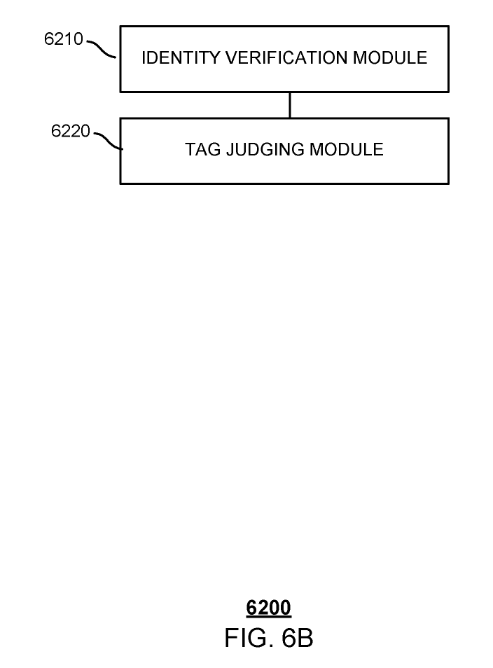

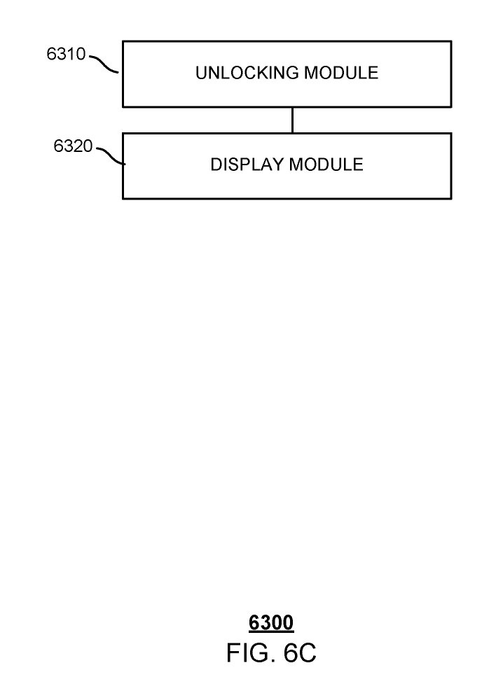

FIG. 3 is a flowchart of an embodiment of a process for processing a fingerprint wake-up offline payment. In some embodiments, the process 300 is implemented by the device or smart terminal 600 of FIG. 6 and comprises:

In 310, the smart terminal collects fingerprint information of at least one user in advance, and configures a fingerprint identifier for fingerprint information of each user.

In 320, the smart terminal selects fingerprint information of a target user, and configures a wake-up tag for the fingerprint information of the target user. In some embodiments, the wake-up tag is configured based on the user's selection. For example, in the event that the user selects a fingerprint, the operating system configures a wake-up tag for the fingerprint.

In the event that the smart terminal used by the user is fitted with hardware such as a fingerprint scanner or a fingerprint sensor, fingerprint verification can be performed. Therefore, fingerprint verification can be used during secure operations such as unlocking, payment, and identity confirmation. Correspondingly, the smart terminal is to collect fingerprints of users to serve as fingerprint information of the users. In some embodiments, each smart terminal configures fingerprint information for one or more users to facilitate verification such as unlocking using different fingers by different users or a single user.

Therefore, fingerprints of at least one finger can be collected in advance to obtain fingerprint information of the user, and a fingerprint identifier can be configured for fingerprint information of each user, then the fingerprint information of the target user is selected and a wake-up tag is configured for the fingerprint information of the target user, i.e., a correspondence is established between the fingerprint identifier and the wake-up tag of the fingerprint information of the target user.

In 330, the smart terminal receives payment fingerprint information in the locked state.

In the event that the screen is in the locked state, the user can enter the fingerprint in the fingerprint scanner, whereupon the system is to receive the fingerprint data, and use the fingerprint data of the designated finger to unlock the system and wake up the payment application. Offline payment can be performed using a single entry, making operations extremely efficient.

Correspondingly, the fingerprint can also be entered in the fingerprint scanner in the event that the screen is in the unlocked state; to prevent operation errors, the execution of verification can be configured to proceed in the event that the fingerprint input is achieved for a certain duration (e.g., the index finger is depressed on a finger sensor for more than 1 second) or is performed a set number of times. Then the verification can be executed based on the fingerprint data.

In 340, the smart terminal compares the fingerprint data with fingerprint information of the user stored in a system.

The fingerprint data and the fingerprint information of the user stored in the system can be compared, whereupon, based on the comparison result, a determination can be made as to whether the unlocking/payment verification has been successful.

In the event that the fingerprint data is found through comparison to match the fingerprint information of the user stored in the system, the match indicates that the user identity check has been successful, and control can pass to operation 350. In the event that the comparison determines that the payment fingerprint data does not match the fingerprint information of the user stored in the system, the process is terminated. In some embodiments, a prompt message can also be returned to the user to inform the user that verification has failed, and the user can re-enter the fingerprint data.

In 350, in response to a determination that the fingerprint data matches the fingerprint information of the user, the smart terminal retrieves a fingerprint identifier of the fingerprint information of the user.

In 360, the smart terminal checks whether the fingerprint data includes a wake-up tag based on the fingerprint identifier.

In some embodiments, in the event that the user enters a fingerprint, the smart terminal is only able to unlock the device or check identity, and the user does not need to perform an offline payment. For example, to unlock the smart device in the locked state, at such times, in response to a determination that a successful comparison serves as passing verification, the offline payment page is not needed by the user and does not have to be displayed. Therefore, to prevent operation errors, after the comparison determines that the payment wake-up data matches the fingerprint information of the user in the system, the fingerprint identifier corresponding to the identical user fingerprint information is retrieved, and the fingerprint identifier is the identifier information of the fingerprint data. Subsequently, the smart terminal checks whether a wake-up tag has been correspondingly configured for the fingerprint identifier.

In response to a determination that the wake-up tag has been correspondingly configured for the fingerprint identifier, i.e., in response to a determination that the wake-up tag has been correspondingly configured for the fingerprint identifier, then the fingerprint data includes a wake-up tag, and control passes to operation 370. In response to a determination that the wake-up tag has not been correspondingly configured for the fingerprint identifier, the fingerprint data does not include a wake-up tag, and the process terminates. In some embodiments, a prompt message is returned to the user to inform the user that verification has failed, and the user can re-enter the data.

In response to a determination that the fingerprint data matches the fingerprint information of the user stored in the system, i.e., the identity check has been successful, and the fingerprint data includes a wake-up tag, then the verification has been confirmed to be successful. In response to a determination that verification has been successfully made, the wake-up of offline payment can proceed.

In 370, the smart terminal unlocks the screen.

In 380, the smart terminal retrieves an offline payment page of the target application, and displays the offline payment page.

In the course of executing verification, by comparing the fingerprint data with the fingerprint information of the user, the unlocking check is essentially executed. Therefore, the smart terminal has confirmed that the fingerprint data matches the fingerprint information indicating that the unlocking check has been successful. Thus, after the verification has been successfully made, the screen can first be unlocked, then the offline payment page of the target application can be retrieved, and the offline payment page can be displayed.

In some embodiments, the wake-up of the offline payment executed based on fingerprint data in the unlocked data is similar to the above operations. Correspondingly, the fingerprint data is received in the unlocked state, and after verification has been successfully made, the offline payment page of the target application can be retrieved. Upon retrieval of the offline payment page, the smart terminal jumps from the current interface to display the offline payment page.

For example, the user separately enters the right thumb fingerprint and the left thumb fingerprint to correspond to the fingerprint information of the user, and correspondingly configures a wake-up tag for identifier information of the left thumb user fingerprint information, so that in the event that the right thumb is used to unlock the device, only the unlocking operation is executed. As an aspect, in the event that the left thumb is used to unlock the device, the offline payment page is displayed to facilitate offline payment.

In other words, some fingers can be configured to unlock the screen, some of these fingers that are configured to unlock the screen can also be configured to invoke the offline payment page.

FIG. 4 is a structural block diagram of an embodiment of an embodiment of a device for data processing. In some embodiments, the device 400 is configured to implement process 100 of FIG. 1 and comprises: a fingerprint collection module 410, a fingerprint recognition module 420, a payment set-up module 430, a payment logic processing module 440, and a payment operation executing module 450.

In some embodiments, the fingerprint collection module 410 is configured to: collect fingerprints of a user and enter fingerprint information of the user and fingerprint data of the user, and configure corresponding fingerprint identifiers (IDs) when entering the user fingerprint information, i.e., each entered fingerprint corresponds to one fingerprint identifier, so that when the fingerprints are entered and the fingerprints can be compared. In the event that the fingerprints are entered, the fingerprint collection module 410 collects the fingerprints to obtain fingerprint information of the user and stores the fingerprint information of the user, and during the fingerprint comparisons, the collected fingerprint data can then be compared against the stored user's fingerprint information by the fingerprint recognition module 420.

In some embodiments, the fingerprint recognition module 420 is configured to: compare the fingerprint data with the fingerprint information of the user; and in response to a determination that the fingerprint data matches the fingerprint information of the user, obtain corresponding fingerprint identifier of the user fingerprint information.

In some embodiments, the payment set-up module 430 is configured to configure a wake-up tag for the selected entered fingerprint (e.g. fingerprint information of the target user) in advance to bind the fingerprint to the offline payment wake-up function, for example, the fingerprint of the left thumb, the fingerprint of the right index finger, etc.

In some embodiments, the payment logic processing module 440 is configured to determine, based on the fingerprint comparison results and the offline payment wake-up settings, whether a payment code page (i.e., an offline payment page) is to be opened. In other words, after the fingerprint comparison is successful, the identifier (ID) of the fingerprint information of the user returned by the fingerprint recognition module 420 is retrieved, and a check is performed to determine whether a wake-up tag is configured for the identifier (ID), i.e., whether the wake-up tag is configured for the fingerprint, and in response to a determination that the wake-up tag is configured for the identifier (ID), the payment operation executing module 450 is notified to open the payment code page.

In some embodiments, the payment operation executing module 450 is configured to wake up the device, unlock the screen, and notify a payment application to display the payment code page. These operations makes it possible to wake up the device in the event that the screen is in the locked state, unlock the screen after receiving notification data from the payment logic processing module 440, and notify the payment application to display the payment code page, and after receiving the notification data from the payment logic processing module 440 in the unlocked state, notify the payment application to display the payment code page.

In some embodiments, the payment application makes the payment code display page interface available to the operating system, so that the payment code display page can be displayed directly after verification has been successful.

In some embodiments, fingerprint recognition technology and offline payment by dynamic payment code are combined to implement a faster payment process, i.e., to wake up offline payment. The user is to only press their finger onto a fingerprint sensor of the mobile terminal to perform a series of operations including wake-up of the device, unlocking of the screen, and presenting of the dynamic payment code, where the payment process is completed with the cooperation of the merchant. Under a precondition of protecting security, this process simplifies a level of complexity of user operations and reduces the payment time, thereby increasing satisfaction in an offline payment user experience.

The modules described above can be implemented as software components executing on one or more general purpose processors, as hardware such as programmable logic devices and/or Application Specific Integrated Circuits designed to perform certain functions or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices. The functions of the modules may be merged into one another or further split into multiple sub-modules.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

FIG. 5 is a structural block diagram of another embodiment of a device for data processing. In some embodiments, the device 500 is implemented to perform the process 200 of FIG. 2 and comprises: a receiving module 510, a verification module 520, and a wake-up and display module 530.

In some embodiments, the receiving module 510 is configured to receive payment wake-up data. In some embodiments, the payment wake-up data includes biometric data.

In some embodiments, the verification module 520 is configured to execute verification based on the payment wake-up data.

In some embodiments, the wake-up and display module 530 is configured to after the verification has been successfully made, display the payment page to execute payment.

With the development of internet finance and O2O technology, an increasing number of users are making offline payments using payment applications in smart terminals. In some embodiments, by entering payment wake-up data, a one-time wake-up of the payment page occurs to execute payment, simplifying the operations. In some embodiments, payment comprises offline payment. In some embodiments, payments targeting transactions that are not conducted online are referred to as offline payments. For example, payments made when a user shops in a physical store, dines in a restaurant, or checks into a hotel all referred to as offline payments.

The user can enter the payment wake-up data on the smart terminal at any time. For example, the payment wake-up data is entered when the screen is in the locked state, or when other applications are being used. In some embodiments, the payment wake-up data includes biometric data to enable recognition of the user based on biometrics, accurately determine the user to display the offline payment page, and increase accuracy and security. In some embodiments, each individual has unique physiological features or behaviors that are measurable or are automatically recognized and verified, i.e., biometrics, and the biometrics are divided into physiological features (such as fingerprints, face images, irises, palm prints, etc.) and behavioral features (such as gait, voice, handwriting, etc.). Biometric recognition is the recognition and authentication of the identity of users based on unique biological features of the users.

Therefore, verification can be executed based on the payment wake-up data. In some embodiments, the verification is used to verify authority to wake up and display the payment page. The verification is used to perform verification of the payment wake-up data, and after verification has been successfully made, the payment page can be displayed to execute payment. The smart terminal correspondingly receives the payment wake-up data, and then performs wake-up of offline payment based on the payment wake-up data, retrieves the offline payment page, and displays the offline payment page. Subsequently, the user can show the offline payment page to the merchant, so that the merchant can perform offline payment operations such as scan to pay.

The payment wake-up data is received. In some embodiments, the payment wake-up data includes biometric data. Verification is performed based on the payment wake-up data. After the verification has been successfully made, the payment page is displayed to execute payment. The accuracy of the verification is increased through the use of biometric data, and, when the user enters the payment wake-up data to enable wake-up of the payment page to execute payment. As a result, the operational steps of payment are simplified, so that operations are simple and efficient, thus saving time.

FIG. 6A is a structural block diagram of an embodiment of a device for processing a fingerprint wake-up offline payment. In some embodiments, the device 600 is configured to implement process 300 of FIG. 3 and comprises a receiving module 610, a verification module 620, a wake-up and display module 630, a collecting module 640, and a tag configuring module 650.

In some embodiments, payment wake-up data includes biometric data. The biometric data includes one or more of the following: fingerprint data, voiceprint data, iris data facial feature data, etc.

In some embodiments, the collecting module 640 is configured to collect the fingerprint information of at least one user, and configure a fingerprint identifier for fingerprint information of each user.

In some embodiments, the tag configuring module 650 is configured to select fingerprint information of a target user, and configure a wake-up tag for the fingerprint information of the target user.

In some embodiments, the receiving module 610 is configured to receive the payment wake-up data.

In some embodiments, the verification module 620 is configured to execute verification based on the payment wake-up data.

In some embodiments, the wake-up and display module 630 is configured to after the verification has been successfully made, display a payment page to execute payment.

FIG. 6B is a structural block diagram of an embodiment of a verification module. In some embodiments, the verification module 6200 is an implementation of the verification module 620 of FIG. 6A and comprises: an identity verification module 6210 and a tag judging module 6220.

In some embodiments, the identity verification module 6210 is configured to perform an identity check with respect to the payment wake-up data based on identity verification information of a system.

In some embodiments, the tag judging module 6220 is configured to in the event that the identity check has been successful, determine whether the payment wake-up data has a wake-up tag, and in response to a determination that the payment wake-up data has the wake-up tag, confirm that the user has passed verification.

In some embodiments, the tag judging module 6220 is further configured to retrieve identifier information corresponding to the payment wake-up data, and check whether the payment wake-up data has the wake-up tag based on the identifier information.

Referring back to FIG. 6A, in some embodiments, the receiving module 610 is configured to receive the payment wake-up data in the event that the screen is in a locked state.

FIG. 6C is a structural block diagram of an embodiment of a wake-up and display module. In some embodiments, the wake-up and display module 6300 is an implementation of the wake-up and display module 630 of FIG. 6A and comprises: an unlocking module 6310 and a display module 6320.

In some embodiments, the unlocking module 6310 is configured to in the event that the verification has been successfully made, unlock the screen.

In some embodiments, the display module 6320 is configured to retrieve a payment page of a target application and display the payment page.

Referring back to FIG. 6A, in some embodiments, the receiving module 610 is configured to receive the payment wake-up data in the unlocked state. In some embodiments, the wake-up and display module 630 is configured to after the verification has been successfully made, retrieve the payment page of the target application and jump to display the payment page.

In some embodiments, the payment wake-up data includes biometric data.

In some embodiments, the example of fingerprint data as the payment wake-up data is used.

Referring back to FIG. 6B, in some embodiments, the identity verification module 6210 is further configured to in the event that the payment wake-up data is fingerprint data, compare the fingerprint data against fingerprint information of the user stored in the system. In some embodiments, the tag judging module 6220 is further configured to in the event that the fingerprint data matches the fingerprint information of the user, retrieve a fingerprint identifier of the fingerprint information of the user, and based on the fingerprint identifier, check whether the fingerprint data has a wake-up tag, and in the event that the fingerprint data has the wake-up tag, confirm that verification has been successful.

The modules described above can be implemented as software components executing on one or more processors, as hardware components such as programmable logic devices (e.g., microprocessors, field-programmable gate arrays (FPGAs), digital signal processors (DSPs), etc.), Application Specific Integrated Circuits (ASICs) designed to perform certain functions, or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present application. The modules may be implemented on a single device or distributed across multiple devices. The functions of the modules may be merged into one another or further split into multiple sub-modules.

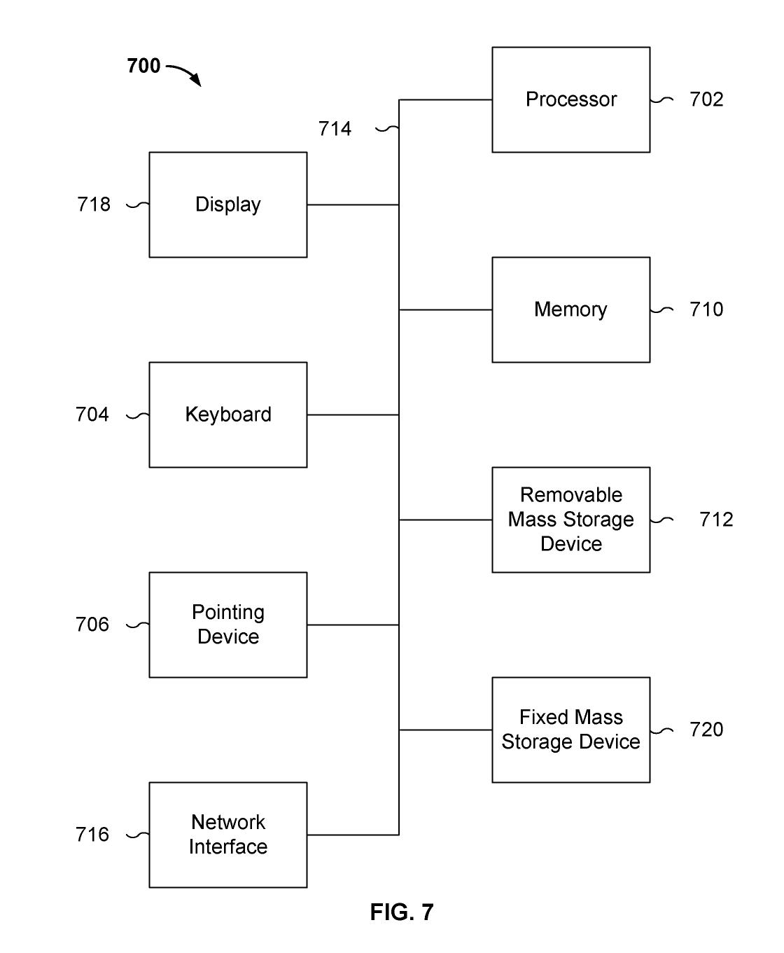

FIG. 7 is a functional diagram illustrating a programmed computer system for data processing in accordance with some embodiments. As will be apparent, other computer system architectures and configurations can be used to perform data processing. Computer system 700, which includes various subsystems as described below, includes at least one microprocessor subsystem (also referred to as a processor or a central processing unit (CPU)) 702. For example, processor 702 can be implemented by a single-chip processor or by multiple processors. In some embodiments, processor 702 is a general purpose digital processor that controls the operation of the computer system 700. Using instructions retrieved from memory 710, the processor 702 controls the reception and manipulation of input data, and the output and display of data on output devices (e.g., display 718).

Processor 702 is coupled bi-directionally with memory 710, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also as is well known in the art, primary storage typically includes basic operating instructions, program code, data and objects used by the processor 702 to perform its functions (e.g., programmed instructions). For example, memory 710 can include any suitable computer-readable storage media, described below, depending on whether, for example, data access needs to be bi-directional or uni-directional. For example, processor 702 can also directly and very rapidly retrieve and store frequently needed data in a cache memory (not shown).

A removable mass storage device 712 provides additional data storage capacity for the computer system 700, and is coupled either bi-directionally (read/write) or uni-directionally (read only) to processor 702. For example, storage 712 can also include computer-readable media such as magnetic tape, flash memory, PC-CARDS, portable mass storage devices, holographic storage devices, and other storage devices. A fixed mass storage 720 can also, for example, provide additional data storage capacity. The most common example of mass storage 720 is a hard disk drive. Mass storages 712, 720 generally store additional programming instructions, data, and the like that typically are not in active use by the processor 702. It will be appreciated that the information retained within mass storages 712 and 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display monitor 718, a network interface 716, a keyboard 704, and a pointing device 706, as well as an auxiliary input/output device interface, a sound card, speakers, and other subsystems as needed. For example, the pointing device 706 can be a mouse, stylus, track ball, or tablet, and is useful for interacting with a graphical user interface.

The network interface 716 allows processor 702 to be coupled to another computer, computer network, or telecommunications network using a network connection as shown. For example, through the network interface 716, the processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect the computer system 700 to an external network and transfer data according to standard protocols. For example, various process embodiments disclosed herein can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow the processor 702 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 7 is but an example of a computer system suitable for use with the various embodiments disclosed herein. Other computer systems suitable for such use can include additional or fewer subsystems. In addition, bus 714 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

1. A method, comprising:
receiving payment wake-up data, wherein the payment wake-up data comprises biometric data;
executing verification based on the payment wake-up data; and
in response to a successful verification based on the payment wake-up data, displaying a payment page to execute payment.

2. The method as described in claim 1, wherein the executing of the verification based on the payment wake-up data comprises:
performing an identity check with respect to the payment wake-up data based on identity verification information of a system;
in response to a determination that the identity check has been successful, determining whether the payment wake-up data includes a wake-up tag; and
in response to a determination that the payment wake-up data includes the wake-up tag, confirming that the verification is successful.

3. The method as described in claim 2, wherein the determining of whether the payment wake-up data includes the wake-up tag comprises:
retrieving identifier information corresponding to the payment wake-up data; and
checking whether the payment wake-up data includes the wake-up tag based on the identifier information.

4. The method as described in claim 1, wherein the executing of the verification based on the payment wake-up data comprises:
comparing fingerprint data against fingerprint information of a user stored in a system; and
in response to a determination that the fingerprint data matches the fingerprint information of the user:
retrieving a fingerprint identifier corresponding to the fingerprint information of the user;
checking whether the fingerprint data includes a wake-up tag based on the fingerprint identifier; and
in response to a determination that the fingerprint data includes the wake-up tag, confirming that the verification is successful.

5. The method as described in claim 4, further comprising:
collecting fingerprint information of at least one user in advance;
configuring a fingerprint identifier for the fingerprint information of the at least one user;
selecting fingerprint information of a target user; and
configuring a wake-up tag for the fingerprint information of the target user.

6. The method as described in claim 1, wherein the receiving of the payment wake-up data comprises:
receiving the payment wake-up data in the event that a screen is in a locked state.

7. The method as described in claim 6, wherein the displaying of the payment page comprises:
after the verification has been successfully made, unlocking the screen;
retrieving the payment page of a target application; and
displaying the payment page of the target application.

8. The method as described in claim 1, wherein the receiving of the payment wake-up data comprises:
receiving the payment wake-up data in an unlocked state.

9. The method as described in claim 8, wherein the displaying of the payment page comprises:
after the verification has been successfully made, retrieving the payment page of a target application; and
jumping to display the payment page of the target application.

10. The method as described in claim 1, wherein the biometric data includes at least one of the following: fingerprint data, voiceprint data, iris data, or facial feature data.

11. The method as described in claim 2, wherein the identify verification information includes unlocking information.

12. A device, comprising:
a processor; and
a memory coupled with the processor, wherein the memory is configured to provide the processor with instructions which when executed cause the processor to:
receive payment wake-up data, wherein the payment wake-up data comprises biometric data;
execute verification based on the payment wake-up data; and
in response to a successful verification based on the payment wake-up data, display a payment page to execute payment.

13. The device as described in claim 12, wherein the executing of the verification based on the payment wake-up data comprises to:
perform an identity check with respect to the payment wake-up data based on identity verification information of a system;
in response to a determination that the identity check has been successful, determine whether the payment wake-up data includes a wake-up tag; and
in response to a determination that the payment wake-up data includes the wake-up tag, confirm that the verification is successful.

14. The device as described in claim 13, wherein the determining of whether the payment wake-up data includes the wake-up tag comprises to:
retrieve identifier information corresponding to the payment wake-up data; and
check whether the payment wake-up data includes the wake-up tag based on the identifier information.

15. The device as described in claim 12, wherein the executing of the verification based on the payment wake-up data comprises to:
compare fingerprint data against fingerprint information of a user stored in a system; and
in response to a determination that the fingerprint data matches the fingerprint information of the user:
retrieve a fingerprint identifier corresponding to the fingerprint information of the user;
check whether the fingerprint data includes a wake-up tag based on the fingerprint identifier; and
in response to a determination that the fingerprint data includes the wake-up tag, confirm that the verification is successful.

16. The device as described in claim 14, wherein the processor is further configured to:
collect fingerprint information of at least one user in advance;
configure a fingerprint identifier for the fingerprint information of the at least one user;
select fingerprint information of a target user; and
configure a wake-up tag for the fingerprint information of the target user.

17. The device as described in claim 12, wherein the receiving of the payment wake-up data comprises to:
receive the payment wake-up data in the event that a screen is in a locked state.

18. The device as described in claim 17, wherein the displaying of the payment page comprises to:
after the verification has been successfully made, unlock the screen;
retrieve a payment page of a target application; and
display the payment page of the target application.

19. The device as described in claim 12, wherein the biometric data includes at least one of the following: fingerprint data, voiceprint data, iris data, or facial feature data.

20. A computer program product being embodied in a tangible non-transitory computer readable storage medium and comprising computer instructions for:
receiving payment wake-up data, wherein the payment wake-up data comprises biometric data;
executing verification based on the payment wake-up data; and
in response to a successful verification based on the payment wake-up data, displaying a payment page to execute payment.
